(19) United States
(12) Patent Application Publication
(10) Pub. No.: US 2008/0252640 A1
(43) Pub. Date: Oct. 16, 2008

(54) SYSTEMS AND METHODS FOR INTERACTIVE REAL ESTATE VIEWING

(76) Inventor: JEFFREY WILLIAMS, Pacific, WA (US)

Correspondence Address: BLACK LOWE & GRAHAM, PLLC, 701 FIFTH AVENUE, SUITE 4800, SEATTLE, WA, 98104, US

(21) Appl. No.: 12/102,721

(22) Filed: Apr. 14, 2008

Related U.S. Application Data
(60) Provisional application No. 60/911,774, filed on Apr. 13, 2007.

(51) Int. Cl. G06T 17/00

(52) U.S. Cl. 345/420

(57) ABSTRACT

In one embodiment, the system and method provides the user with the ability to interact with a piece of real estate using a 360 degree full range of motion. The software further enables a user to change textures/features at will. A 3D virtual environment is used so developers can classify and group objects and textures so that these objects and textures can be modified and/or moved. The system provides an end user with the ability to modify and/or move the groups of objects and/or textures so they can see in a virtual environment what the property will look like. The data selections of the user choices can then be saved and uploaded in one embodiment.

### PRIORITY CLAIM

This application claims priority to U.S. Provisional Patent Application No. 60/911,774 filed on Apr. 13, 2007, the subject matter of which is incorporated herein by reference in its entirety.

### BACKGROUND OF THE INVENTION

Currently, when a customer shops for real estate, the customer travels to each piece of property. On arrival, the customer views the property and leaves with some paperwork describing the property and possibly some photographs, or in the case of uncompleted new construction, a sketch up or architectural drawing of what the property will look like. At the end of the day, the customer has a series of papers all with pricing information and a select mix of pictures. The customer then may make a determination based on the pictures alone and may forget about those homes that not provide the most aesthetically pleasing flyers.

Alternatively, some properties offer virtual tours over the Internet. The customer can click through and be given a 360 degree tour of a particular room. This view is taken from a single video and takes a lot of bandwidth to transfer the video. Usually the video only exists for one room and generally does not show all of the aspects of the property.

Finally, in new construction, there are buyer centers or mock ups of an actual kitchen or living room and this allows a buyer to “walk” through what a property may look like. Also there is a modeled display of the property and a potential layout of the piece of real estate. While this gives the customer an idea of what the property looks like, it often does not allow them to take anything home to assist in their decision making.

Further, in new construction, a customer has the ability to select upgrades to the property. These may include, but are not limited to: paint, carpet, cabinets, appliances, landscaping, and the like. Usually a customer goes to a design center or to a supplier's shop (i.e., Sears, Home Depot, and the like) and the customer selects their upgrades from the range of products. In this case, the customer currently does not have a medium to look at both the upgrade choices and how those choices will look in their home. Currently, customers are unable to view a potential new home, from their home, and interact with the features and the layout while trying to decide whether or not to buy the home.

### SUMMARY OF THE INVENTION

In one embodiment, the system and method provides the user with the ability to interact with a piece of real estate using a 360 degree full range of motion. The software further enables a user to change textures/features at will. A 3D virtual environment is used so developers can classify and group objects and textures so that these objects and textures can be modified and/or moved. The system provides an end user with the ability to modify and/or move the groups of objects and/or textures so they can see what the property will look like in a virtual environment. The data selections of the user choices can then be saved and uploaded in one embodiment.

### BRIEF DESCRIPTION OF THE DRAWINGS

The preferred and alternative embodiments of the present invention are described in detail below with reference to the following drawings.

FIG. 1 provides a general description of a computing environment that may be used to implement various aspects of the present invention;

FIG. 2 shows a method of classifying objects in one embodiment;

FIG. 3 shows a method for grouping objects in one embodiment;

FIG. 4 shows what the Interactive Real Estate Viewer looks like when it is loaded by the end user the first time;

FIG. 5 shows a method for selecting groups of objects;

FIG. 6 shows a method for changing the texture on a selected object; and

FIG. 7 shows how the cabinets look different after the changes have been made.

### DETAILED DESCRIPTION OF THE PREFERRED EMBODIMENT

In one embodiment of the present invention, a program is created, that contains information about a home. The program contains information about the home displayed to the user in three dimensions, allowing the user to view a virtual fly over of the home and property, walk through the property and selectively change the features of the home and view information on the neighborhood.

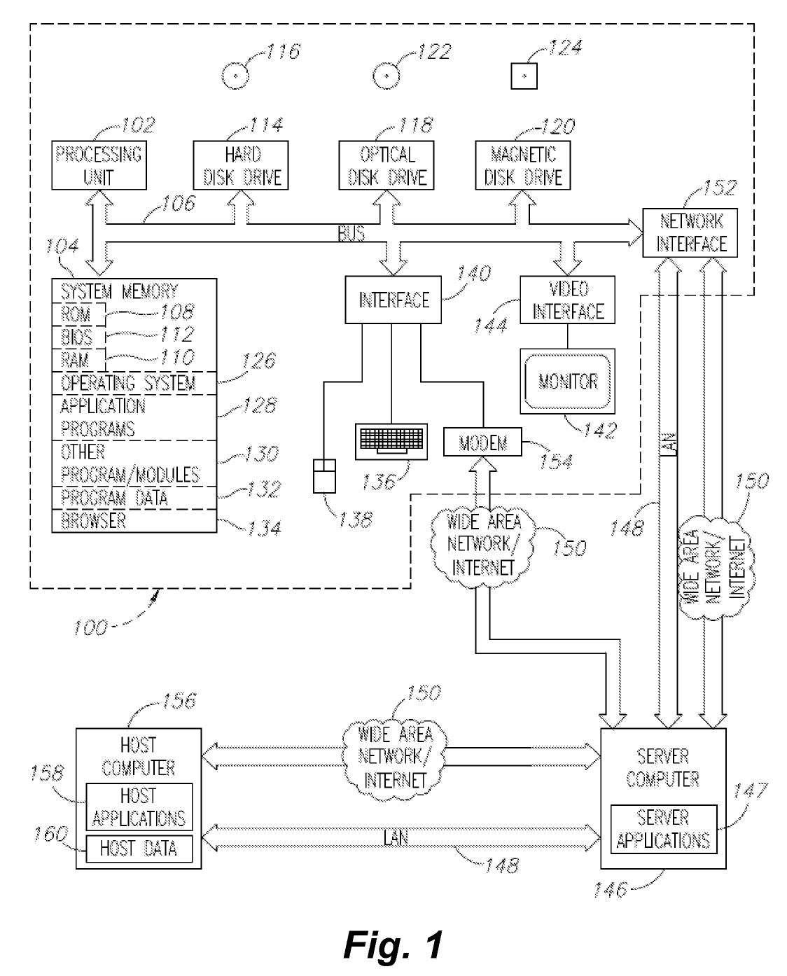

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include, but is not limited to: personal computer systems, hand-held devices, multiprocessor systems, microprocessor-based or programmable consumer electronics, network PCs, mini computers, mainframe computers, and other equivalent computing and processing systems and sub-systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

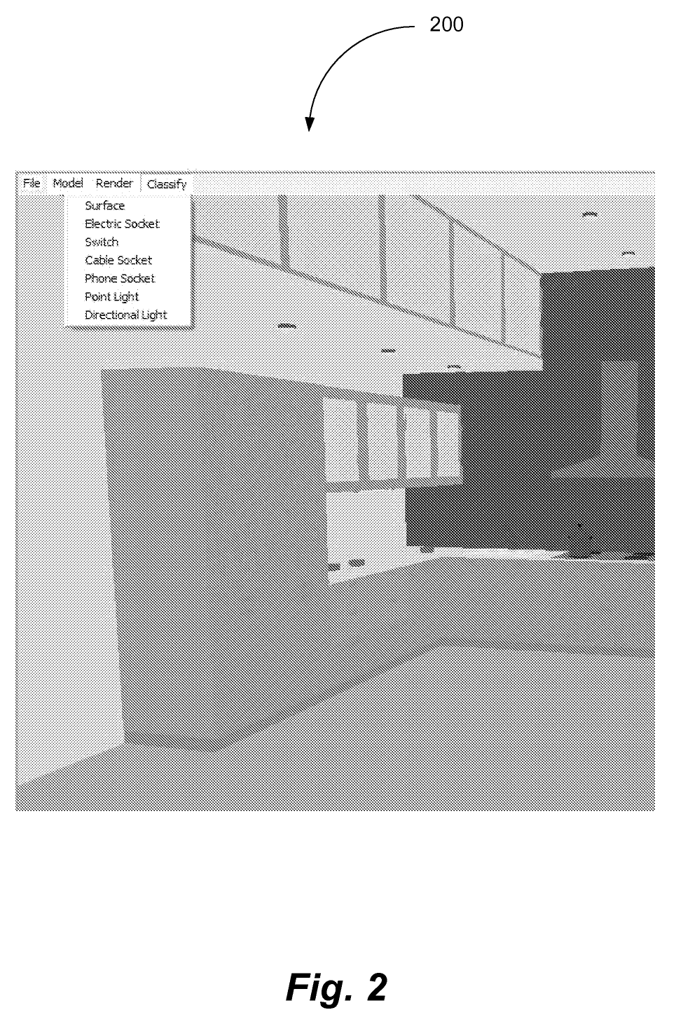

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 10 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers and the like.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as 3D home related data.

In order to develop the program, 3D renderings are created based upon a builder's floor plans. Once the model programmer receives the floor plans, which come in different forms, for example, they may be received as blue prints or an auto-cad program or in the form of a .pdf file, they then plot the different points of the exterior walls and the internal walls. These points are determined by a mapping grid. Each point has a value based upon its location on a “X” and “Y” axis. Once these points have been determined then a 3 dimensional value can be established for the “Z” axis. It is the “Z” axis which provides for the depth of the 3D environment. Once the 3D modeling has been created the programmer can then determine the plotting system for the other elements of the home. For example, once the internal & external walls have been created the placement of windows, doors, bathtubs, cabinets, etc. can be determined according to the builders plans. The measurements for the placement of these items are then taken from the builders plans, scaled and created according to the 3D model. When all of the attributes of the home have been created and placed, the 3D model looks like a skeleton, wire frame view of the home. In order to create a recognizable environment textures are preferably applied to the different parts of the home model. In one example, in order to be able to texture these surfaces polygons must be created in order to define a specific surface. Once the polygons have been created they can be linked together creating groups of polygons. These groups of polygons can then be labeled. Once the groups have been labeled, i.e., cabinets, kitchen counter tops, doors, lights, etc. they can be textured. Texturing occurs when the programmer selects a group of polygons and then applies the appropriate texture and then auto fills those polygons that make up the different surfaces. When all of the surfaces have been filled with textures the 3D rendering is complete. All of the textures that were used to create the 3D model are stored along with all of the optional textures the end user can choose from when personalizing their new home. When the 3D modeling is complete it then goes to the operation's programmer who then programs the ability for 360 degree full range of motion. At this time lighting and shadowing is applied so that the user can experience a true virtual environment.

Once modeling is complete and when a user receives a disk, or accesses the software via the internet, they first encounter the main menu. From the main menu, the user will have various selections to choose from. One selection they can choose from is a data sheet. The data sheet includes, but is not limited to: home specifications, floor plans, pictures, warranties, site map, list of subcontract and service providers, utility providers, community features such as; daycare, hospital, schools, grocery, recreation. In an alternate embodiment community features can be accessed by a separate program allowing the viewer to enter the name of a business they are seeking and the software will locate and map the location of matching selections. There is no limitation as to the type of data that is placed on the disk or stored on the internet via services. If there is data that is pertinent to the application it can be stored and viewed.

Another selection a user can choose from is a virtual fly through with a narrative voice over. Once selected, the user will experience a guided tour through the home. Upon the start of the flythrough the user will begin the tour from the front of the home. The narrative voice over will give the opportunity for the viewer to learn about the products the builder uses in the construction of the homes. So as you are moving towards the front of the home. The viewer learns what kind of siding the builder uses, what kind of roofing materials is used. The narrator then explains the advantages of these products and why the builder uses them. The narrator also explains the benefits of the products the builder uses. This process is continued throughout the home. The user has the opportunity to move from room to room with a narration explaining the features, advantages, and benefits of each room.

By demonstrating to the user the quality of the products used to construct the home, they can then make informed decisions when it comes to the process of buying a new construction home. The same features, advantages and benefits can also be found in the data portion for reference purposes.

The user will also notice a toolbar at the bottom of the screen giving them the ability to stop, fast-forward, rewind, pause, skip forward/reverse, as well as main menu return. In an alternative embodiment, the fly through can be made from a high definition video camera. An example of the narrative voice might be, as you enter the kitchen the first thing that catches your eye is the cabinetry. This home features brand A cabinets in all of their homes. Brand A cabinets are handcrafted and use all natural materials. Because Brand A uses all natural materials, some darkening or mellowing of the wood will occur due to the natural and artificial lighting they may receive. The benefit is that each specie of the wood exhibits its own unique and distinctive pattern and characteristics which adds to their beauty over time.”

By the end of the fly over the viewer will have a better understanding of the products that are used in the construction of the home. By allowing the consumer the opportunity to review this information as often as they choose. From the comfort of their current home, they do not have to go out of their way each and every time they would like to tour the home by having to travel to the construction site.

When a user selects to enter the virtual 3D rendering of the house, they are entering a scaled model of the house, including all of the features to be included by the builder. The user views the world from a first person point of view. The user preferably is able to walk around and interact with the house as if they were truly walking through. By way of an example, the user using computer keys enters the kitchen. On entering the kitchen, the user walks up to an appliance, in this case the stove. The user can activate the stove, crouch down to look into the oven, use the burners, etc. then if not satisfied the user is prompted with a design window of other options available in that space. In one embodiment the list of other options is provided by the seller, in other embodiments the user is sent to a third party company and selects an alternate stove. Once the alternate stove is selected it is placed in the 3D rendering and the user continues to interact with it until satisfied. The user then can continue to tour the home.

The user tours the home as a first person would and because of that it is like a real walk through. The user can see the views from the window and can place a couch as they like it in the room. Further included are how lighting effects the home, the sun angle, view, noise level, etc. As the user continues to build there dream home, they can save and upload there plans in order to remember all of there selections.

When the user enters a virtual 3D and as they travel from room to room they have the opportunity to click on any part of the room that the builder allows changes to be made. The user can move from room to room through the use of designated keys on the keyboard or the use of a joystick etc. As a viewer travels from room to room they will experience and feel as if they are actually within the home. The viewer will be able to see all of the internal walls, trim, molding, light fixtures, light switches and outlets. Because of the proximity technology used in this software, if the viewer passes by a light switch they can click on it and either turn on/off the lights that are controlled by that switch as if in the real world. When the viewer enters a room that has features that can be changed, the viewer can then click on the specified feature and a menu will appear (i.e., drop down screen, scroll bar, or pop up screen, or navigation bar). From that menu the user can choose from the builders list of options for that specific feature. For example, if the viewer were to scroll over the counter tops and select by clicking the mouse, a design menu would appear allowing the user an array of choices. The user could choose from 1 of 2 categories, standards, or upgrades. Should the user choose standard they would simply make their selection, from the choices provided and clock on it. Should the user choose upgrade, they would click on “upgrade” and a design menu would appear with those choices. The user would then have the opportunity to choose from any one of the upgrades and their associated costs would then be calculated and shown to the viewer. As the user travels from room to room changing options and selecting their choices, a running tally of the upgrade cost will be viewable allowing the user to remain informed as to the cost of the home. This feature allows the user to prioritize those upgrades important to them. In an alternate embodiment, once the user has made all of their selections and is ready to save the information they can access a mortgage calculator by clicking on the tool bar. With the mortgage calculator, the viewer can determine the monthly mortgage payments associated with the cost of their new home.

In essence a buyer can design and customize their new home to their satisfaction in the convenience of their current location. The choices can then be saved, printed, and/or uploaded so they will have a list of all their selections and upgrades. This list can then be used to draw up a purchase and sales agreement. In an alternate embodiment the Interactive Real Estate Viewer can be used as a home decorating tool, allowing the user to place items, such as furniture, in the house.

In one embodiment, the Interactive Real Estate Viewer allows the grouping together of objects, textures, and/or other polygons, so that a single texture and/or color can be assigned to the group of objects and/or polygons. For example, the designer can designate that all kitchen cabinets are in the same group, and as such when a user changes the texture and/or color on one cabinet it affects all of the cabinets.

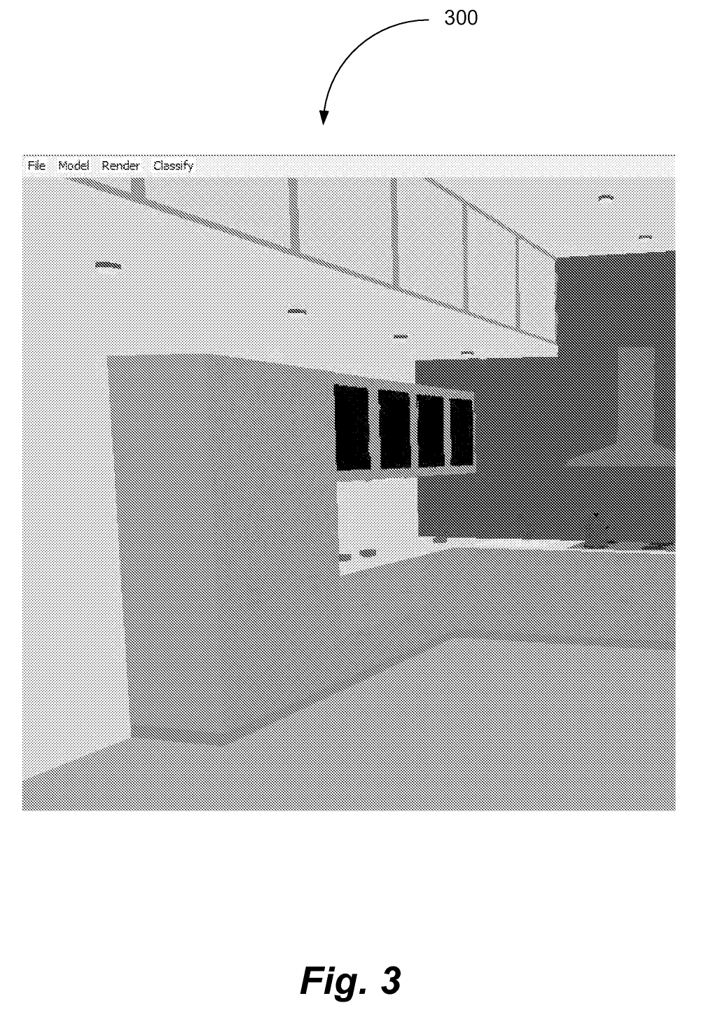

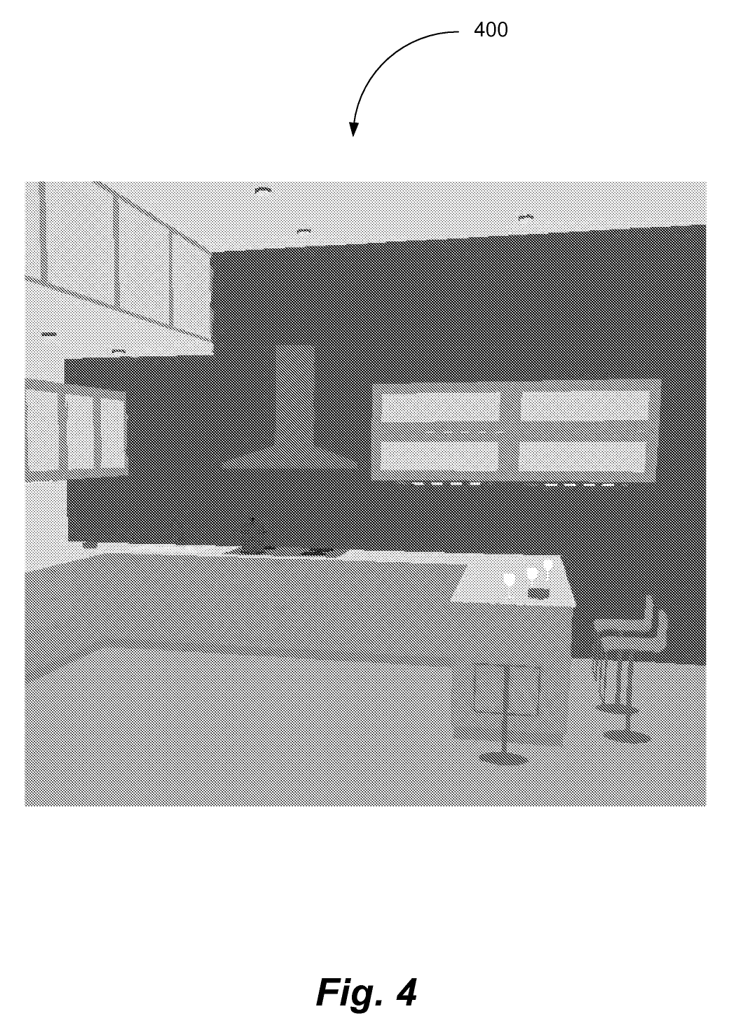

The system and method for editing the model that is loaded into the Interactive Real Estate Viewer is overviewed below: 1. Once the floor plan is obtained from the builder a 3D model is created using 3D modeling software; 2. The model is then loaded into our 3D editor program using custom model conversion tools; 3. The 3D editor program has the ability to detect when the user clicks on an object or surface; 4. The 3D model editor program allows the changing of attributes, which includes but is not limited to the classification, color, texture, properties, size, style, and grouping of polygons and/or objects. The grouping together of these polygons and/or objects, is important in that a single texture can be assigned to the group of polygons and/or objects. (shown in screenshot 200 of FIG. 2, screenshot 300 in FIG. 3 and screenshot 400 in FIG. 4); 5. This is then saved to a custom file; and 6. The model and textures can then be loaded into the Interactive Real Estate Viewer program that can be utilized by the end user.

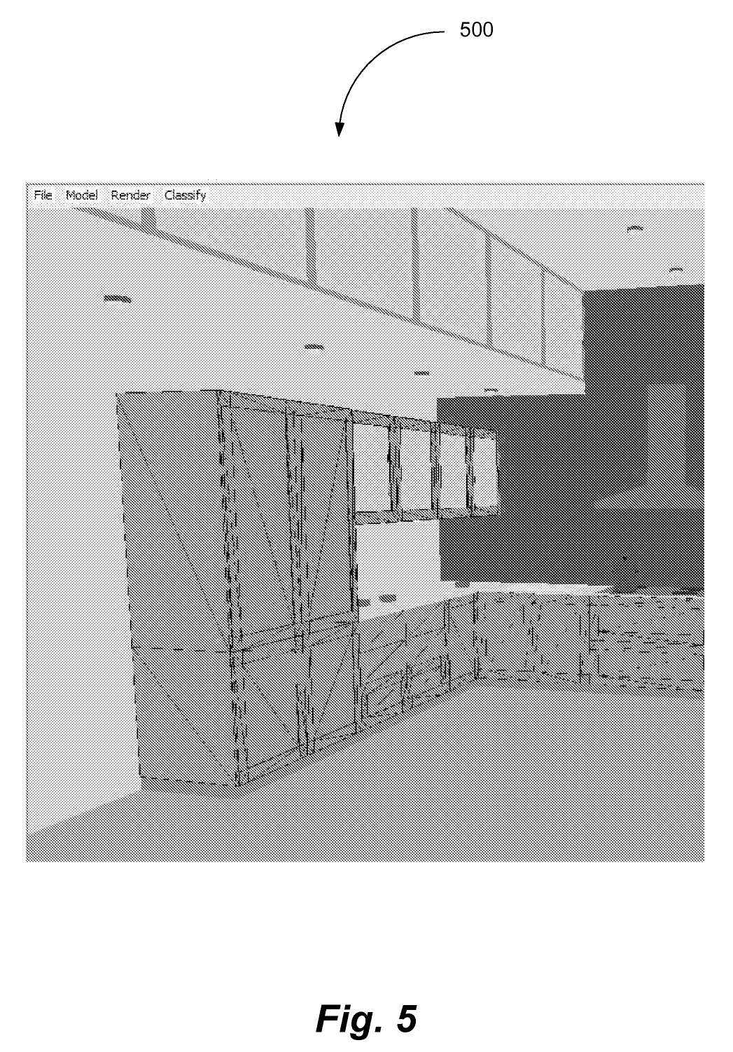

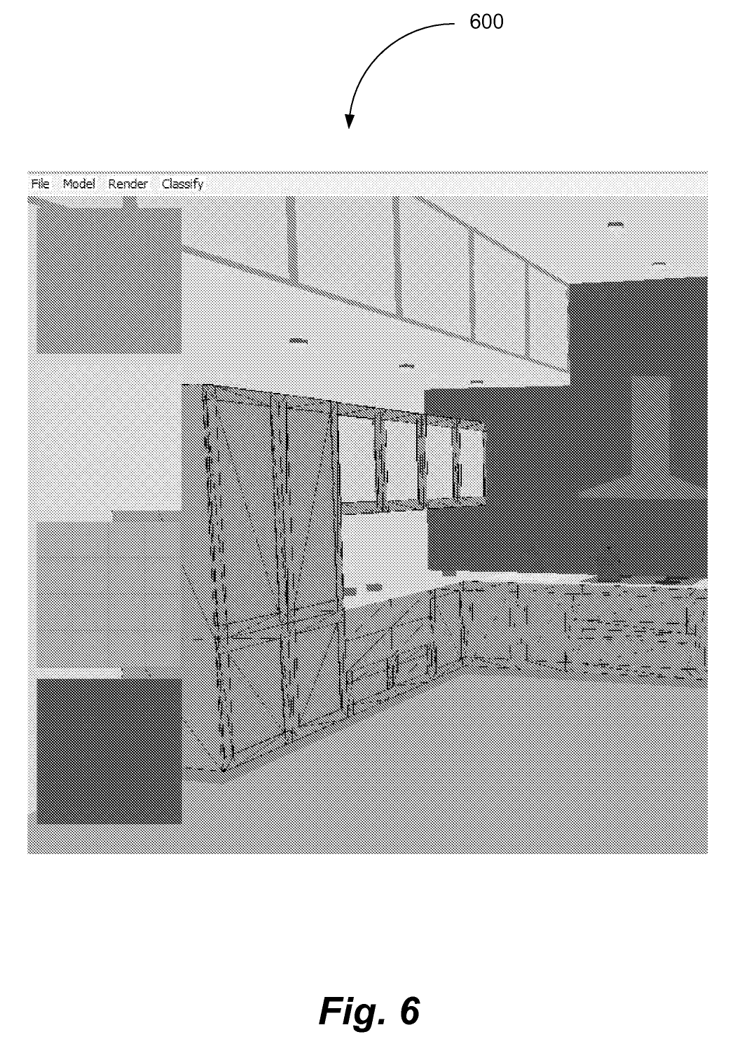

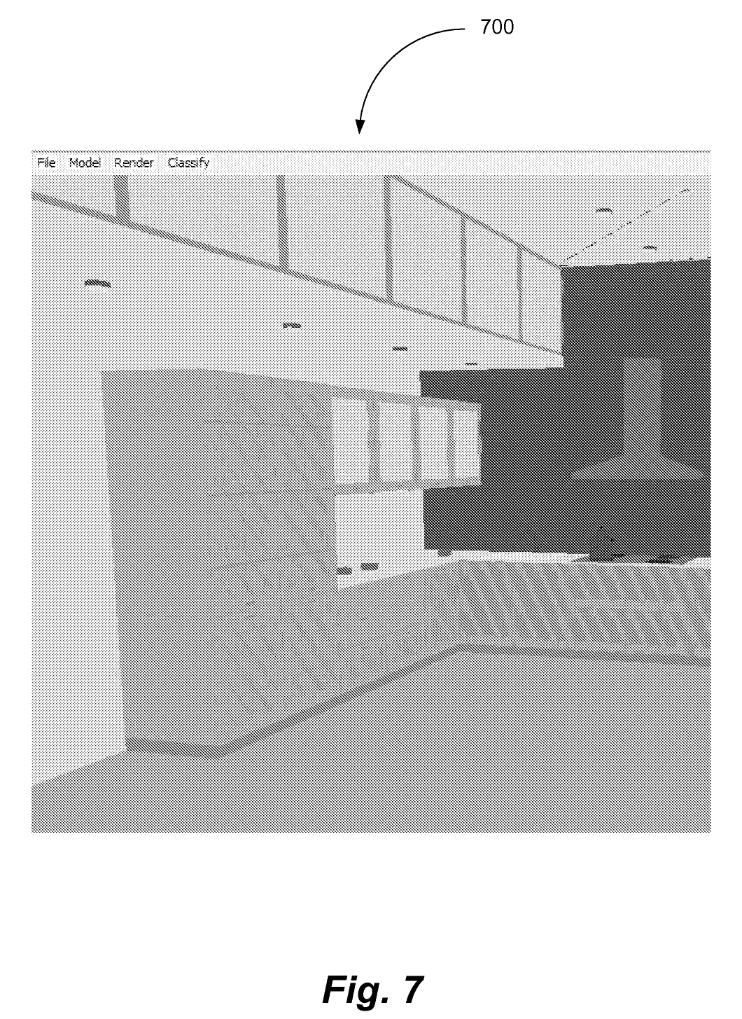

The system and method for the consumers use of the Interactive Real Estate Viewer is overviewed below: 1. The model is automatically loaded upon the launch of the Interactive Real Estate Viewer; 2. The user is presented with a virtual environment with a 3D home model loaded that they can interact with immediately; 3. The user can move around with the W, A, S, D keys (Later versions may also be mapped to alternative keys), and to look around by holding down the right mouse button and dragging the mouse in the direction they want to go; 4. The 3D Viewer program has the ability to detect when the user clicks on an object or surface; 5. The user can click on objects to select them. The additional objects that have been grouped with the selected object will also show as selected by the Interactive Real Estate Viewer program. (shown in screenshot 500 of FIG. 5) Once an object or objects are selected, the user can change the texture or color by holding down the left “Control” key (Later versions may be mapped to alternative keys). A menu will pop up on the left with texture choices. (shown in screenshot 600 of FIG. 6) The user can then click on a texture or color choice and all of the objects in that group will then change to that desired texture or color. (shown in screenshot 700 of FIG. 7).

Once the consumer has finalized their choices, they may save and possibly upload the texture choices to a recipient. In an alternative embodiment, these choices may be printed for future reference.

Advantageously, the system and method as described above allow a home builder, home seller, or real estate agent to develop a 3D rendering of the home. The rendering is then given to the potential buyer for their use at home. The buyer then can continue to interact with the home and can customize the home in order to truly be satisfied before making an offer. The buyer is allowed to make any changes or upgrades and generally will know what they are getting and how it is going to look and feel before offering to buy the home. This good feeling about making an offer builds good will in the builder, seller or agent and in turn results in a happier better informed customer.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for interactive real estate viewing comprising:
loading three dimensional model of a home;
displaying a virtual environment with a three dimensional home, configured such that a user can interact with the virtual environment;
enabling a user to move around the virtual environment as if they were touring the home;
presenting a user with a list of modifiable attributes of the home; and
storing changes made to the home by the user for later use.
